(19) United States
(12) Patent Application Publication
(10) Pub. No.: US 2003/0034189 A1
(43) Pub. Date: Feb. 20, 2003

(54) Slick track

(76) Inventors: Gary Lemke, Grand Rapids, MN (US); Brad Lemke, Grand Rapids, MN (US); Cary Safe, Grand Rapids, MN (US); Edgar Hetteen, Grand Rapids, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/165,412

(22) Filed: Jun. 6, 2002

Related U.S. Application Data
(60) Provisional application No. 60/296,633, filed on Jun. 7, 2001.

(51) Int. Cl. B60V 1/00

(52) U.S. Cl. 180/116

(57) ABSTRACT

A tracked vehicle capable of traversing a variety of surfaces without damaging the surface traversed. The vehicle is capable of light or heavy-duty applications. An embodiment of the vehicle includes a track with a substantially smooth outer surface, and an inner surface including a portion having lugs, a driver sprocket assembly engaging the lugs, and a plurality of wheels spaced to minimize flexing of the track between each wheel in contact with the track while the track contacts the traversed surface.

This application claims the benefit of Provisional U.S. patent application Serial No. 60/296,633, filed Jun. 7, 2001.

### FIELD OF THE INVENTION

The invention relates to a multi-surface vehicle, and more particularly to the suspension and drive mechanism associated with a multi-surface vehicle with an elastomeric track.

### BACKGROUND OF THE INVENTION

A variety of track driven vehicles have been around for many years. Tracked vehicles vary from 100 ton military tanks and bull-dozers to 300 pound snowmobiles. Track types vary from segmented steel tracks to one piece molded rubber tracks.

One of the major design challenges with all types of tracks and vehicles is to find the most efficient way to transfer the torque of the drive mechanism to the track with minimum power loss. There are many torque transmission systems. The three most common torque transmission systems are an external drive, a friction drive and an internal drive. External drives include a sprocket with a fixed number of teeth around the circumference that drives against a rigid member attached to the track. The sprocket teeth protrude through the track to a point where the rigid members can not slip back under a heavy load. Friction drives include a wheel attached to the drive axle and drive against the inside surface of a track. The outside of the wheel and the inside of the track are typically made of resilient material such as rubber or other composites. The track tension must be extremely tight to prevent slippage. The track tension also results in power loss. Internal drive systems, also known as involute drives, have a track with drive lugs attached to the inside surface of the track. The drive lugs may be molded to the inside surface of a rubber track. The drive sprocket is made by attaching rigid drive teeth to a rigid radius wheel. The sprocket teeth drive against the internal drive lugs on the track.

Internal drive systems are generally considered the most efficient drive for tracks made of elastomeric material such as rubber when the drive lugs and drive sprockets are properly matched. They are properly matched when the pitch diameter of the sprocket matches the pitch line of the track. Another way of determining whether they are properly matched is when the pitch diameter of the sprocket causes the drive teeth to match perfectly with the center to center distance between the track drive lugs. In practice, proper matching is difficult to achieve especially when using an elastomeric or rubber track. Tracks made of elastomeric materials are resilient. As a result, the elastomeric material stretches or contracts slightly depending on a number of factors. One of the more common factors that causes changes in the pitch length is the variation in the load applied to a track during operation of the multisurface vehicle. The load on the track and on the internal lugs will be higher when the vehicle is pulling a log as compared to the load on the track applied to merely move the vehicle over terrain. The tracks may be loaded differently when turning. An outside track will typically be loaded to a higher degree when compared to an inside track. The pitch length of the track varies with the variations in the load applied to the track.

Variations in the pitch length of the track results in a mismatch between the pitch length of the track and the pitch diameter of the sprocket. When using a sprocket having rigid drive teeth, the change in the pitch length along the track causes the sprocket teeth to “scrub in” or “scrub out” or both. In other words, the rigid tooth is rubbing between the individual drive lugs on the internal surface of the flat belt. This causes a loss in efficiency. Scrubbing in or out can result in extreme power loss and excessive wear on the track drive lugs and sprocket teeth.

Another common problem with flat tracks such as those made from an elastomeric material is that foreign matter or sticky material builds up in the sprocket area. Metal tracks usually have openings through which at least some foreign matter may be passed. The buildup is worse on a flat track. When foreign matter builds up in the sprocket area the pitch diameter or the pitch line of the flat track is likely to change. This results in power loss and excessive wear. Rocks, sticks, grass, mud, snow and other materials may build up in the sprocket area.

Military tanks and bull-dozers are two common vehicles featuring metal tracks. Metal tracks are typically mounted on drive wheels and idler wheels that are mounted on springs or suspension systems that allow the drive wheel to move slightly from a fixed position. The use of rollers on the track drive segments of a metal track reduces noise and reduces wear between the individual segments of the metal track. The springs or suspension associated with the idler wheels allows the metal track to accommodate obstacles encountered by the metal track. At the drive wheels, the springs also accommodate slight variations in pitch diameter.

Metal tracked vehicles have many problems. One of the problems is that metal tracked vehicles are very heavy and tend to sink in and damage relatively soft surfaces. The pressure produced by a metal tracked vehicle is relatively high. For example, when a metal tracked vehicle operates in mud, the vehicle typically sinks to solid ground rather than passing over such a surface. The tracks also are tough on surfaces such as grass or lawns. The pressure produced by the metal track of a bull-dozer or a tank typically produces indentations in a surface. For example, if a bull-dozer passes over a residential lawn, the pressure is high enough to compact the earth and form a permanent indentation. A home owner would have to fill in the impressions with additional soil to fix the lawn. In addition, the metal tracks typically have square edges which dig into surfaces during turns. A turning bull-dozer would rec havoc with residential lawns. Metal tracks can also become derailed.

Some tracked vehicles have used rubber tracks. Typically, designers of metal tracked vehicles carry over many of the design characteristics into flat track vehicles using elastomeric or rubber tracks. Many of the problems encountered with metal tracks are also encountered with rubber tracks. For example, many rubber track designs include a track mounted on drive wheels or sprockets which are spring mounted. The problem of matching the pitch line of the track to the pitch diameter of the sprocket is further exacerbated. The drive wheels do not maintain the track near a constant state of tension so the pitch line can fluctuate widely.

In addition, the drive sprocket is positioned so that it is in contact with the surface. Typically, the drive sprocket will be at the rear of the vehicle and positioned so that the track passes between the drive wheel and the ground. In such designs, the rear drive wheel has two jobs. The rear drive wheel drives the track and maintains the alignment of the track. When the rear drive wheel is on the ground, the two jobs the rear drive wheel is called on to do work against one another. When driven, the track tends to want to leave the drive wheel or “jump off the sprocket”. It is necessary to maintain alignment to prevent derailing. Rear drive wheels on the ground are more prone to derailing since the forces associated with doing the two jobs counteract one another. Another problem with rear drive wheels on the ground is that they tend to require additional complexity. Elongated gear boxes must be used to transfer power to these rear on the ground drive wheels.

Another problem associated with flat elastomeric tracked vehicles is that there are few idler wheels that contact the ground. The track tends to bow between the idler wheels which results in a loss of traction. In addition, with fewer points on the ground and bowing between the wheels, the effective surface pressure at various points under the wheels is high. The tracked vehicle does not have an even pressure across the flat track. Still another problem is that these vehicles are high maintenance. Each individual wheel must be greased periodically. In addition, since the environment for use includes foreign matter such as dirt, the individual idler wheels tend to wear. Because of the high maintenance and cost, there is a tendency to use lesser numbers of wheels in various designs.

As a result of high pressure per wheel, most designs of tracked vehicles using elastomeric or steel tracks are not environmentally friendly. Current designs still indent soft surfaces and tear up grass lands. In addition, the current vehicles are high maintenance. High maintenance is needed to assure that the components of the undercarriage do not prematurely wear.

Thus, there is a need for a for a tracked vehicle that produces a low pressure on the surface and which is environmentally friendly. In addition, there is a need for a lower maintenance vehicle not prone to derailing the track. In addition, there is a need for a vehicle which has many contact points, and therefore has lower pressure per wheel, on the track as it passes over the surface. There is also a need for a vehicle which does not require constant greasing and cleaning of the wheels in contact with the track. There is also a need for a vehicle which places the drive sprocket off the ground so as to eliminate complexity in the design and yet effectively transmit power to the tracks. In addition, there is a need for a sprocket which will accommodate the changes in the pitch line of an elastomeric flat track. In addition, there is a need for a sprocket which will not “scrub” between the driving lugs. There is also a need for a sprocket which is self cleaning and which removes debris from the sprocket area to minimize problems associated with debris build up changing the pitch relationship between the sprocket and the flat track.

### SUMMARY OF THE INVENTION

A tracked vehicle capable of traversing a variety of surfaces without damaging the surface traversed. The vehicle is capable of light or heavy duty applications. An embodiment of the vehicle includes a track with a substantially smooth outer surface, an inner surface including a portion having lugs for engaging a driver sprocket and a plurality of wheels spaced to minimize flexing of the track between each wheel in contact with the track while the track contacts the traversed surface.

Another embodiment of the vehicle includes a body mount system, dual undercarriages, a track drive system, an end axle system, a multi-axle system, and a plurality of wheels which all help to maintain optimal surface contact between the track and the underlying surface. In this embodiment, multiple wheels across the width and length of the track eliminate bowing between the wheels and distribute the downward force imparted by the multi-surface vehicle. The track is kept substantially straight across the wheels to increase the efficiency associated with transferring power to track. This results in improved vehicle stability and traction as well as less compaction to the underlying surface. The drive sprocket is positioned above the ground so as to eliminate complexity in the design and yet effectively transmit power to the tracks. Positioning the drive sprocket above ground also prevents derailing of the track. The track is also held in a constant state of tension about the driver sprocket and the end axle system. This too prevents derailment. The undercarriage of the vehicle includes axle assemblies including sealed bearings to provide for a lower maintenance track. Components associated with the undercarriage do not require constant greasing and cleaning of the wheels. The track includes a treaded or substantially smooth outer surface and beveled outer edges so that it does not rip up surfaces. The drive sprocket is provided with roller sleeves that accommodate the changes in the pitch line of an elastomeric track. The sprocket assembly does not “scrub” the areas between the driving lugs. The drive sprocket includes a pair of scrapers which provide self cleaning and which remove debris from the sprocket area.

Advantageously, the vehicle will travel over soft surfaces without causing damage to the surface. Unlike other vehicles, the vehicle sinks little in soft mud or snow. The resulting vehicle is very effective in transmitting power to the surface over which it passes. The vehicle requires very low maintenance since the bearings associated with the undercarriage are sealed. Other suspension units require little or no maintenance. The vehicle also is less prone to track derailment.

### BRIEF DESCRIPTION OF THE DRAWINGS

The following detailed description of the preferred embodiments can best be understood when read in conjunction with the following drawings, in which:

FIG. 1 is a side view of an embodiment of the multi-surface vehicle.

FIG. 2 is perspective view of an embodiment of the undercarriage of the multi-surface vehicle.

FIGS. 3a and 3b are perspective views of an embodiment of the track used with the multi-surface vehicle.

FIGS. 4a and 4b are top views of an embodiment of the track showing the tread pattern.

FIG. 5a is a cross-sectional view along line 5a-5a in FIG. 4a.

FIG. 5b is a cross-sectional view along line 5b-5b in FIG. 4b.

FIG. 6 is a cross-sectional view along line 6-6 in FIG. 4a showing the idler wheels in phantom engaging the lugs of the track.

FIG. 7 is an exploded perspective view of an embodiment showing multiple wheels attached to a single axle assembly having multiple wheels and sealed bearings.

FIG. 8 is a perspective view of an embodiment of the multi-axle system.

FIG. 9 is a perspective view of an embodiment of the drive sprocket assembly including scrapers.

FIG. 10 is a cross-sectional view showing an embodiment of a body mount system including a torsion mount.

FIG. 11 is a partial perspective view of an embodiment of the undercarriage of the multi-surface vehicle as it engages an obstacle on the surface being traversed.

### DETAILED DESCRIPTION

In the following detailed description, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

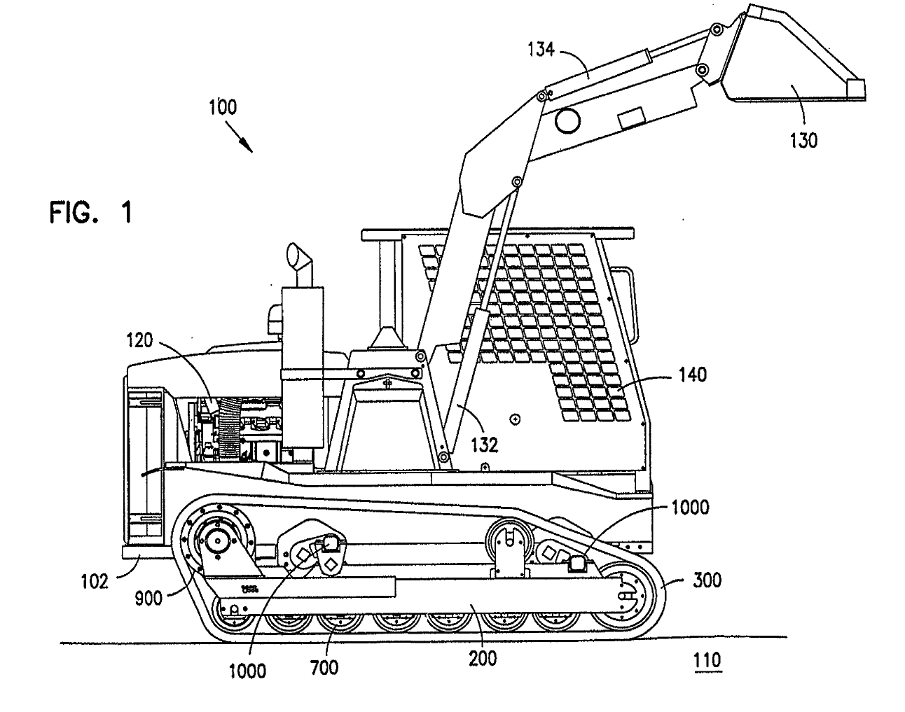

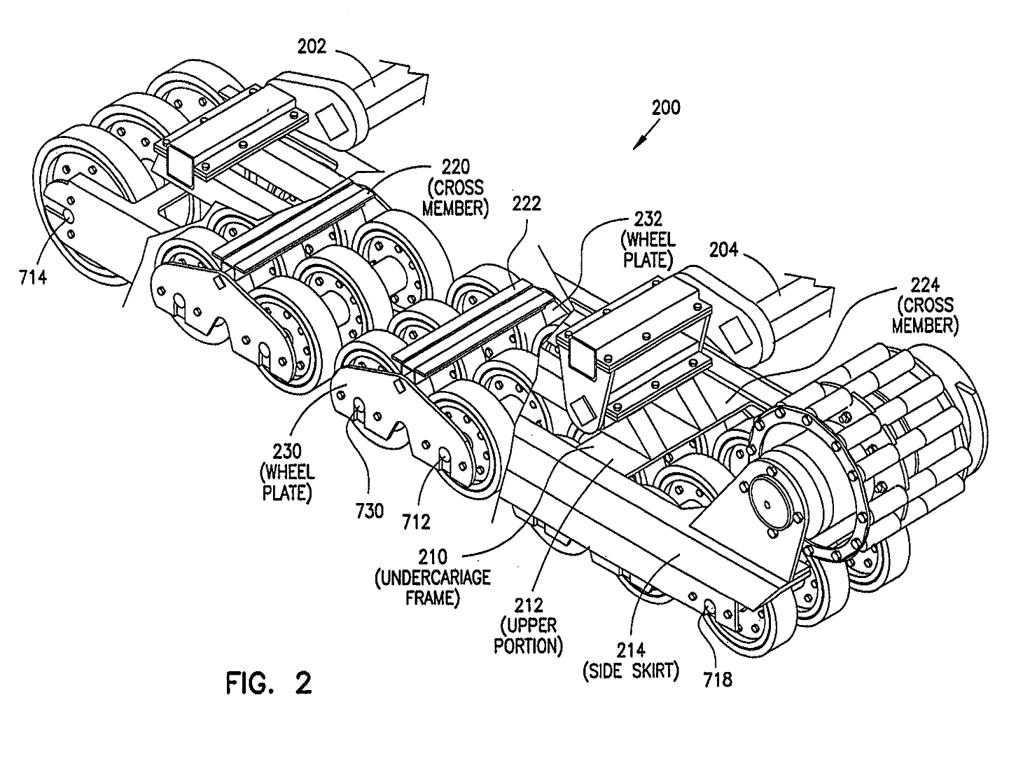

FIG. 1 shows a perspective view of an embodiment of the multi-surface vehicle 100 on a surface 110. The multi-surface vehicle 100 includes a body frame 102 which carries an engine 120 such as an eighty horsepower, 4.5 liter John Deere PowerTech Diesel or a one hundred fifteen horsepower, 4.5 liter John Deere PowerTech Turbo Diesel. Both of these engines are available from John Deere and Company of Moline, Ill. The engine 120 powers a hydrostatic transmission which powers hydraulic drive motors with planetary gear boxes which eliminates additional chains and sprockets, thereby lessening the complexity and increasing the efficiency of the drive system. Two auxiliary pumps are used to power different accessories. As shown, the multi-surface vehicle 100 includes a loader/bucket accessory 130. The engine 120 powers hydraulic pumps used to drive the hydraulic cylinders 132 and 134 for operation of the loader 130. Other accessories, such as a blade or logging device may be substituted for the loader 130. The vehicle 100 also includes an operator cab 140. The operator cab 140 is equipped with controls for controlling the loader 130 and for operating the multi-surface vehicle 100. Attached to the body frame 102 of the multi-surface vehicle 100 is an undercarriage 200. A duplicate undercarriage 200 is attached to the other side of the body frame 102. The undercarriage 200 is attached to the body frame 102 via body mount systems 2000 utilizing torsion mounts 1000. The undercarriage 200 includes a drive system 9000 including a drive sprocket assembly 900 for driving an elastomeric or rubber track 300. It should be noted that the drive sprocket assembly 900 is positioned off the surface 110 so that it will stay clean for a longer life. The undercarriage 200 features multiple wheels 700 on axle assemblies (shown in FIG. 2) which engage the inner portion of the track 300 as the track engages the surface 110. The wheels 700 are of a selected diameter and spaced so that the track 300 will not bow between the contact points as the track 300 travels over the surface 110. The properties of the elastomeric track 300 also are selected so that the track 300 has a sufficient stiffness so that the track 300 stays substantially straight between the contact points of the various wheels 700. As shown in FIG. 1, eight different axle assemblies carrying wheels 700 are shown in contact with the track 300. The wheels 700 provide multiple contact points which more evenly distribute the weight of the vehicle 100 and its load over the two tracks 300. By keeping the individual tracks 300 substantially straight between the various contact points, the track 300 is also better able to grip the surface 110.

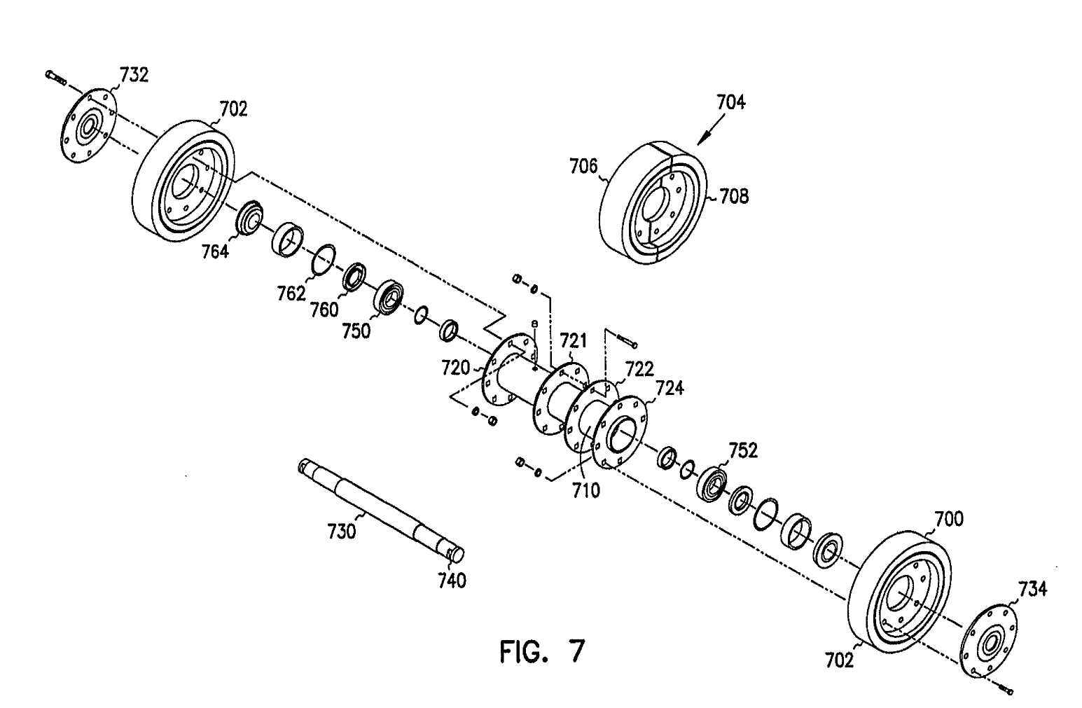

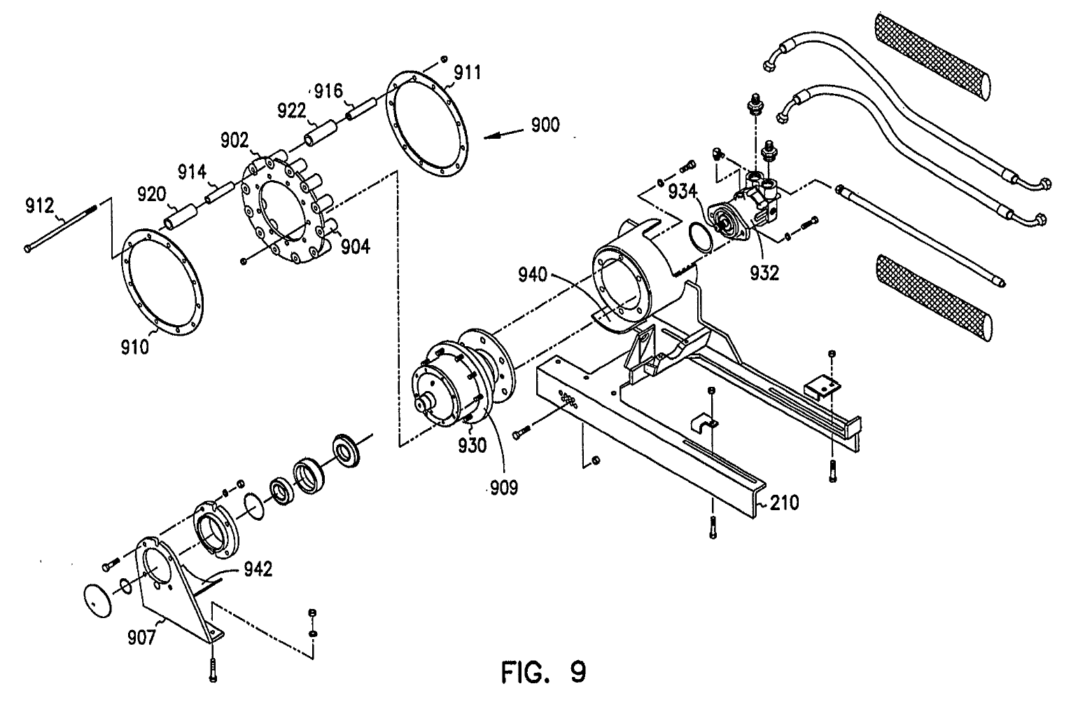

FIG. 2 is an embodiment of one side of the undercarriage 200 of the dual undercarriage 200 multi-surface vehicle 100. As can be seen from this view, there are two frame members 202 and 204 which are part of the body frame 102 of the vehicle 100. The undercarriage 200 includes an undercarriage frame 210 which includes an upper portion 212 and a side skirt 214. Attached to the undercarriage frame 210 are cross members 220, 222, and 224. The cross members support a multi-axle system 7002. The multi-axle system of this embodiment includes a laterally positioned torsion mount 1000. The torsion mount 1000, which will be described in more detail in FIG. 9, provides an essentially maintenance free component which does not require greasing or regular cleaning. Attached to each end of a torsion mount 1000 supported by cross member 222 is wheel plate 230 and wheel plate 232. The wheel plates 230 and 232 are described here. For the sake of clarity, the other wheel plates are not numbered. The other wheel plates attached to torsion mounts 1000 supported by cross members 220 and 224 are substantially identical to the wheel plates 230 and 232 attached to the torsion mount 1000 supported by cross member 222. Each wheel plate 230 and 232 carries two axle assemblies 710 and 712. Each axle assembly 710 and 712 carries three wheels 700. The wheels 700 are described later in reference to FIG. 7. FIG. 2 also shows end axle system 7001. The wheels 700 of the first end axle assembly 714 and second end axle assembly 718 are fixed with respect to the undercarriage frame 210. The end axle assemblies 714 and 718 are actually in a fixed position in a notch in the side skirt 214 of the undercarriage frame 210.

Also attached to the undercarriage frame 210 at a position above the end axle assembly 718 is drive sprocket assembly 900. The drive sprocket assembly 900 is in a fixed position with respect to the undercarriage frame 210. It should be noted that the wheels 700 on the first end axle assembly 714, the wheels on the second end axle assembly 718, and the drive sprocket 900 are all in fixed position with respect to the undercarriage frame 210. These particular wheels 700 of end axle system 7001 and the drive sprocket assembly 900 define the outer limits of the track 300. It is important to have a substantially fixed position for these wheels 700 and the drive sprocket assembly 900 so that the track 300 is held in a substantially constant state of tension. The pitch length of an elastomeric track 300, such as those made of rubber, will vary slightly. The pitch length will stretch slightly as variable loads are applied to the track 300.

As can be seen, the plurality of wheels 700 provide for a plurality of contact points onto the internal surface of the track 320. In fact in this embodiment, the eight axle assemblies 710, 712, 714, 718 within the end axle system 7001 and multi-axle system 7002 each having 3 wheels provide for a total of 24 contact points to the internal surface of each flat track 300. The multi-surface vehicle 100 has a duplicate undercarriage 200 on the other side of the vehicle 100. Forty eight wheels 700 distribute the weight evenly over the two tracks 300 so that superior traction and flotation are achieved. There is also a minimal amount of force at each contact point. The ground pressure associated with the vehicle 100 is minimized improving the capability of the vehicle 100 to work on soft ground or lawns without forming ruts or compacting soil.

Of course to keep the soil from compacting or forming ruts, the track 300 is formed of a material which is stiff enough such that it will not bow between the contact points of the wheels 700 and the track 300 remains substantially in contact with the surface 110 being traversed.

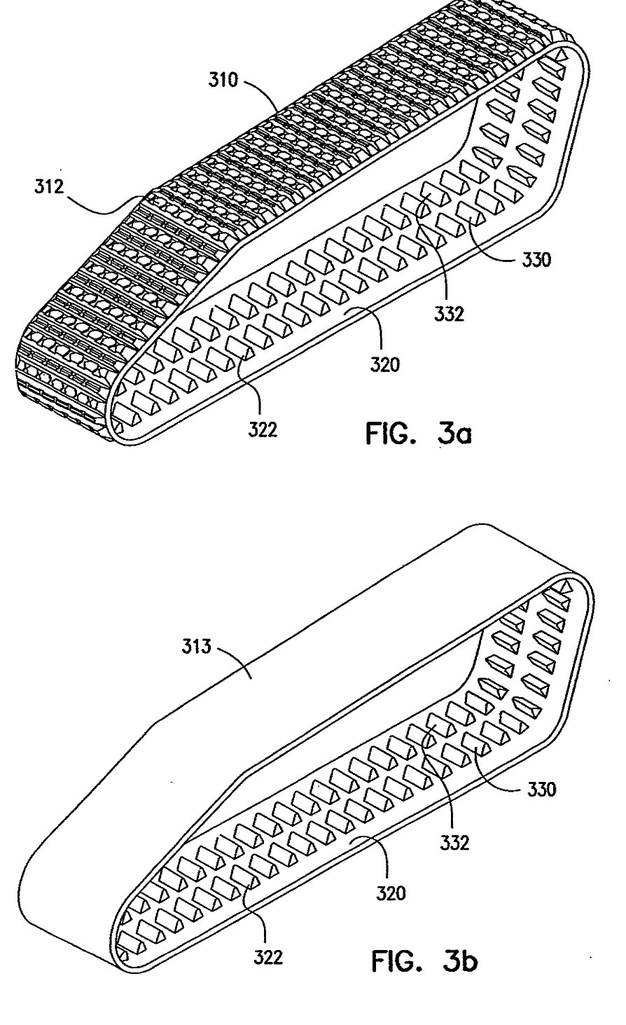

FIGS. 3a and 3b are perspective views of embodiments of the track 300 used with the multi-surface vehicle 100. The track 300 has an inner surface 320. Attached or molded to the inner surface 320 of the track 300 are a plurality of drive lugs 322. The drive lugs 322 are arranged in two rows 330 and 332. The spacing between the rows 330 and 332 is selected so that the width of the middle wheels 700 on a three wheel axle assembly 710, 712, 714, 718 fits between the first row 330 of drive lugs 322 and the second row 332 of drive lugs 322. Typically approximately one-half inch of clearance is provided so that the track 300 can shift an appropriate amount during a turn or other operation. The outer wheels 700 fit between one row of lugs 322 and the outer edge of the track 300. The spacing from one lug 322 to another within a row is selected so that the lugs 322 will properly engage the drive sprocket assembly 900. Proper engagement would match the pitch diameter of the drive sprocket assembly 900 to the pitch line of the track 300. Of course, this is difficult to achieve since there are different forces on the track 300 at various times. FIG. 3a is an embodiment of the track 300 having an outer surface 310 which has a tread pattern 312. FIG. 3b is an embodiment of the track having an outer surface 310 which is a substantially smooth outer surface 313.

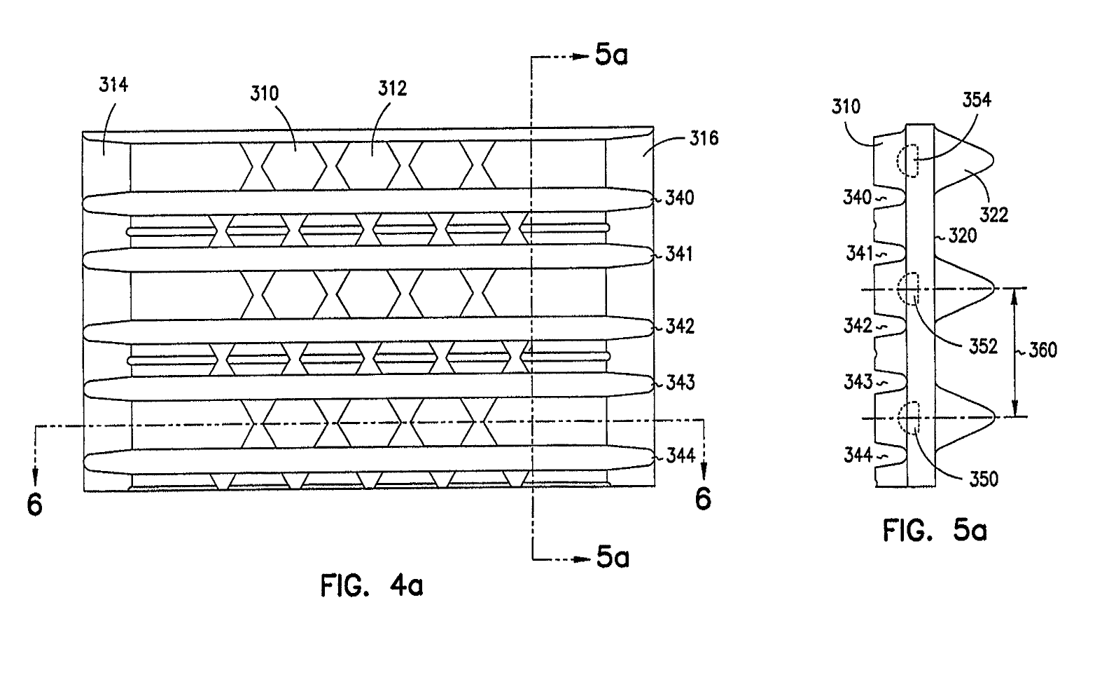

FIGS. 4a and 4b are top views of embodiments of the outer surface 310 of a section of the track 300. The outer surface 310 includes a first beveled edge 314 and a second beveled edge 316. The beveled edges 314 and 316 allow some side-to-side movement which accommodates turns made with the elastomeric track 300. The allowance of the side-to-side motion from turning makes for a very environmentally friendly track 300. Unlike square edged tracks that typically dig into the ground and produce track damage, the beveled edges 314 and 316 on the track 300 can traverse the ground during a turn to leave the terrain substantially undamaged. FIG. 4a shows an outer surface 310 having a tread pattern 312 including a series of transverse grooves 340, 341, 342, 343, and 344. The transverse grooves 340, 341, 342, 343, and 344 are at a selected spacing and at a selected depth so as to leave ribs between the grooves. The ribs formed between the grooves 340, 341, 342, 343, and 344 are dimensioned so that after the track passes over the wheels 700 associated with the end axle assembly 714 or 718 of end axle system 7001 and come into contact with the ground, the ribs close and grip the vegetation or the ground surface 110 for added traction. FIG. 4b shows an outer surface 310 which is a substantially smooth outer surface 313.

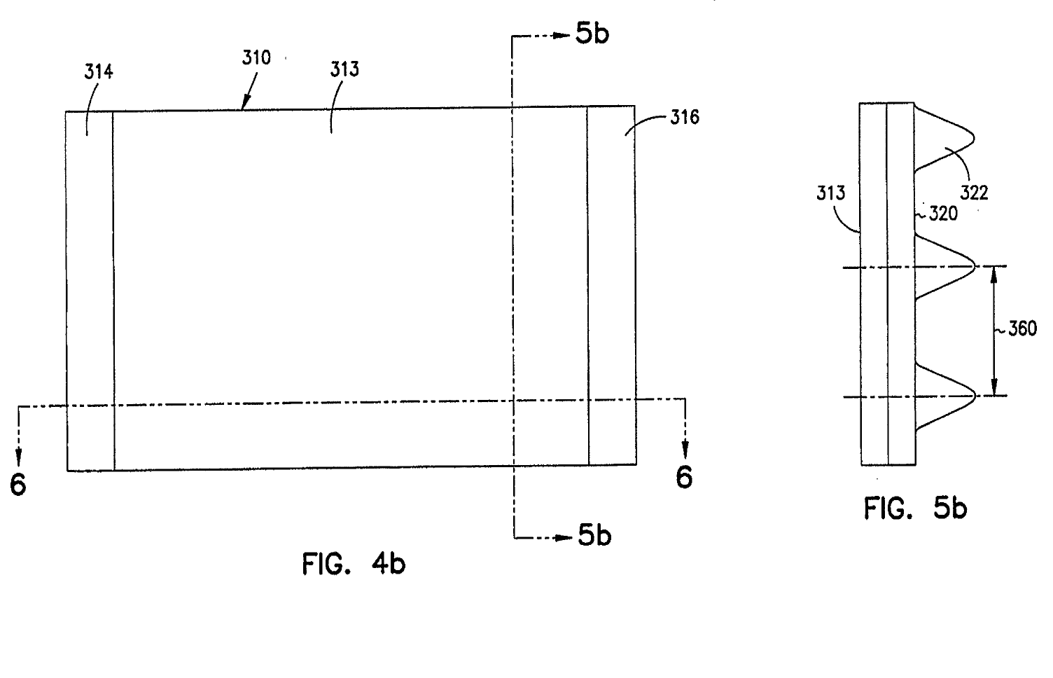

FIG. 5a is a cross-sectional view along line 5-5 in FIG. 4a. Both the inner surface 320 and the outer surface 310 of the track 300 are shown in this view. The track may includes stiffeners 350, 352, and 354. The stiffeners 350, 352 and 354 increase the stiffness of the track 300 across the width of the track 300. The stiffeners 350, 352 and 354 are typically fiberglass rods which are molded into the track. The stiffeners 350, 352 and 354 are placed in the wider ribs such as those formed between grooves 341 and 342, and formed between grooves 343 and 344.

FIG. 5b is a cross-sectional view along line 5-5 in FIG. 4b. Both the inner surface 320 and the outer surface 310 of the track 300 are shown in this view. In this embodiment the track is devoid of stiffeners 350, 352, and 354.

In the embodiements shown in FIGS. 5a and 5b, the driving lugs 322 are shown molded or attached to the inner surface 320 of the track 300. The distance between the lugs 322, depicted by the reference number 360 is selected so that the engaging portions of the drive sprocket assembly 900 engages the portion of the inner surface 320 between adjacent lugs 322 in a row. Ideally, the engaging portion of the drive sprocket assembly 900 would engage the lugs 322 with little or no backlash or extra spacing located between the lugs 322. This is difficult to achieve given that the pitch of the elastomeric track 300 will stretch slightly as a function of the load placed on the track 300.

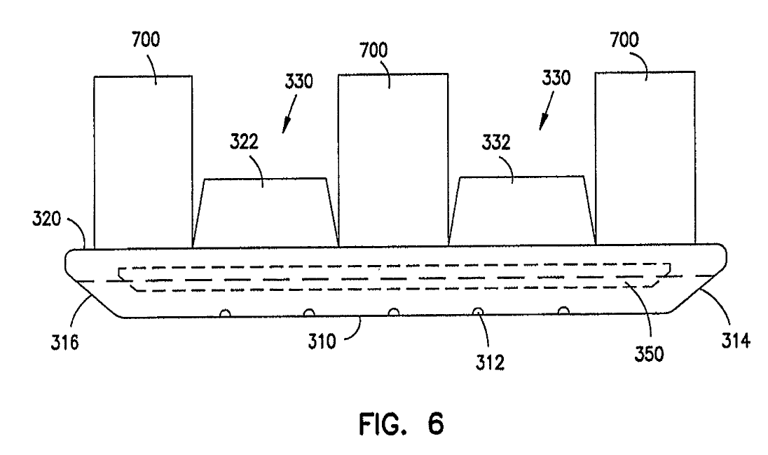

FIG. 6 is a cross-sectional view along line 6-6 in FIG. 4a. The wheels 700 contacting the inner surface 320 of the track 300 have been added in phantom to FIG. 6. The rows 330 and 332 of lugs 322 are spaced such that the wheels 700 of the undercarriage 200 fit between the rows 330 and 332 and between the rows 330 and 332 and the outer edges of the track 300 such that the lugs 322 limit the side-to-side motion of the track 300 and prevent the track from dislodging or jumping off. The wheels 700 do not fit tightly with respect to the rows 330 and 332 of lugs 322. This allows for slight movement of the track 300 with respect to the wheels 700 attached to a single axle assembly, such as axle assembly 710 (shown in FIGS. 2 and 7). Another aspect of these driving lugs 322 is that the spacing on them allows the track 300 some lateral movement. The lateral movement enhances the turnability of the vehicle 100.

One stiffener 350 is shown in FIG. 6. The stiffener 350 is molded into the track 300 and is a fiberglass rod 350 positioned transverse to the path of travel. The transverse fiberglass rods 350 strengthen the track 300. The fiberglass rod 350 terminates well short of the beveled edges 314 and 316 so as to prevent the stiffener 350 from releasing from the flat track 300. On other tracks, the release of a fiberglass rod from the track was a precursor to track failure. As a result, the fiberglass rod 351 is stopped well short of the end of track 300 and then enveloped in five to seven layers of Kevlar or another tire cording material. This prevents the stiffener 350 from leaving the track 300 thereby forming a weak spot in the track.

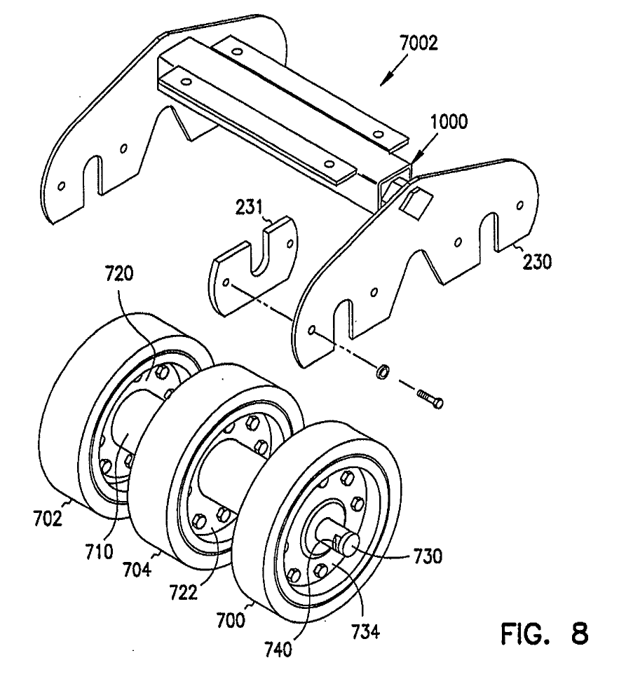

FIG. 7 is an embodiment showing multiple flanges 720, 721, 722, and 724 attached to a single axle assembly 710. FIG. 8 shows an assembled axle and attached wheels. Now turning to FIGS. 7 and 8, the wheels 700 are attached to the flanges 720, 724 and between flanges 721, 722. There are two types of wheels 700. The first type of wheel 700 is an outside wheel 702 which fits flanges 720 and 724 on the ends of the outer shaft 735 . The second type of wheel 700 is an intermediate wheel 704. The intermediate wheel 704 attaches between flanges 721 and 722 intermediate the two ends of the outer shaft 735 of the axle assembly 710. The intermediate wheel 704 comprises a first half 706 and a second half 708. Each of the two halves 706 and 708 is split along a diameter of the wheel 704 to form two semicircular halves. The two semicircular halves 706 and 708 are bolted between flanges 721 and 722 on the axle assembly 710 to form an intermediate wheel 704. The outside wheels 702 and the intermediate wheel 704 include a plastic or metal disk and rim with an elastomeric tire. The disks are bolted to the flanges 720, 724 and between flanges 721 and 722. The outside wheels 702 are provided with an endcap 732 and an endcap 734.

The axle assembly 710 includes an outer shaft 735 which is a hollow tubular element. The flanges 720, 721, 722, and 724 are attached to the outer shaft 735 . The outer shaft 735 is mounted on an inner shaft 730. The inner shaft 730 has two ends which protrude from the ends of the outer shaft 735 . The outer shaft 735 is rotatably attached to the inner shaft 730 by a first roller bearing set 750 and a second roller bearing set 752. The entire inner portion of the axle assembly 710 between the outer shaft 735 and inner shaft 730 is filled with oil or grease. The rollers in each of the bearing sets are in a cage. The roller cage and the bearings are submersed in the oil or grease found within the axle assembly 710. The roller bearings 750 and 752 are also provided with multiple seals. Use of a sealed bearing sharply reduces maintenance time and keeps the life of the bearings high. Each end is provided with three seals. The bearing has a first seal 760, an annular plastic or rubber element that fits over one side of the bearings, which comes with the bearing set 750 and 752. A second seal 762 is positioned outside of the bearing set 750 and 752. A third seal 764 includes seven different seals in one. The third seal 764 has a tortuous path to prevent dirt from getting into the bearing set 750 and 752 or into the space between the outer shaft 735 and the inner shaft 730. If dirt or other contaminants get into the grease or the oil covering the bearing sets 750 and 752, the life of the bearings will be shortened. However, dirt entering through the third seal 764, the second seal 762, and the first seal 760 would have to pass through nine seals in order to get to the lubricant.

Including a plurality of wheels 700 on an axle assembly 710 reduces manufacturing cost and also provides for a maintenance free part that lasts up to the life of the multi-surface vehicle 100. FIG. 8 shows the wheels 700 attached to the flanges 720, 721, 722, 724 on outer shaft 735 of the axle assembly 710. The inner shaft 730 is shown protruding from the sealed end of the axle assembly 7000. The inner shaft 730 extends beyond the endcap 734. The inner shaft 730 includes a keyway 740 that engages a wheel plate 230. The wheel plate 230 includes an axle capture plate 231 which, when bolted to the wheel plate 230, captures the inner shaft 730 of the axle assembly 7000 in positions 710 and 712 between the wheel plate 230 and axle capture plate 231. Only one axle capture plate 231 is shown in FIG. 8.

FIG. 9 is a perspective view of an embodiment of the drive system 9000 including the drive sprocket assembly 900 which engages the drive lugs 322 on the track 300. A first scraper 940 and a second scraper 942 clear the drive sprocket assembly 900 of debris that may otherwise accumulate. The drive sprocket assembly 900 includes a central drive plate 902. A number of tubular elements 904 are welded or otherwise attached to the central drive plate 902. Attached to the central drive plate 902 is a first annular ring 910 and a second annular ring 911. As shown, the first annular ring 910 and a second annular ring 911 are attached to the central drive plate 902 using a long bolt or pin 912. A set of spacers 914 and 916 are assembled over the pin 912 and are used to define the spatial relationships between the central drive plate 902 and the first annular ring 910 and the second annular ring 911. Spacers 914 and 916 also carry roller sleeves 920 and 922. The roller sleeves 920 and 922 roll with respect to the spacers 914 and 916 and with respect to the central drive plate 902. The roller sleeves 920 and 922 fit between the central drive plate 902 and the first annular ring 910, and between the central drive plate 902 and the second annular ring 911. The roller sleeves 920 and 922 are dimensioned and spaced so that they can engage the spaces between the drive lugs 322 on the inside portion 320 of the elastomeric track 300. The roller sleeves 920 and 922 are advantageous in that they are self adjusting. As the track 300 passes over a roller sleeve 920 and 922, the pitch of the track 300 actually changes since the track 300 is elastomeric. The roller sleeves 920 and 922 accommodate such changes in pitch since they can roll between the drive lugs 322 rather than scrub the inner surface 320 between the drive lugs 322. The end result is that the roller sleeves 920 and 922 also prevent chatter or extra vibrations at various speeds of the track 300.

The central drive plate 902 of the drive sprocket assembly 900 is attached to a sprocket driving mechanism 930. The sprocket driving mechanism 930 is supported by brackets attached to the undercarriage of the frame 210. The sprocket driving mechanism 930 includes a housing having first scraper 940. Also attached to the sprocket driving mechanism 930 is a hydraulic pump 932. The hydraulic pump 932 is attached to a source of hydraulic fluid. As hydraulic fluid is passed through the hydraulic pump 932 an output shaft 934 turns a planetary transmission system housed within the sprocket driving mechanism 930. The central drive plate 902 is attached to an annular ridge 909 on the sprocket driving mechanism 930. A second scraper 942 is attached to one of the plates supporting the drive sprocket assembly, plate 907, which is attached to the undercarriage frame 210. There are a series of seals and a cap 905 that prevent contamination of the sprocket driving mechanism 930 with dirt or other contaminants.

The scrapers 940 and 942 force and remove debris from the drive sprocket assembly 900 and deposit it outside the drive sprocket assembly 900 and away from the track 300. This is critical since build up of debris within the sprocket will generally tend to change the pitch line of the track 300 further. In addition, debris build up tends to act to dislodge or derail the track 300 from the drive sprocket assembly 900. The first scraper 940 and the second scraper 942 are cantilevered in toward the central drive plate 902 and are positioned near the roller sleeves 920 and 922 of the drive sprocket assembly 900. The scrapers 940 and 942 are cantilevered to extend between the sprocket driving mechanism 930 and the roller sleeves 920 and 922 of the drive sprocket assembly 900. The scrapers 940 and 942 are arcuate in shape to dislodging mud and other debris from the driver sprocket assembly 900 and place the debris elsewhere.

The placement of the driver sprocket assembly 900 reduces the likelihood of the track becoming dislodged, when compared to other vehicles. Now referring FIGS. 1, 2 and 9, the drive sprocket assembly 900 is placed off the surface 110, and toward the rear of the vehicle 100. The drive sprocket assembly 900 pulls the track 300 into alignment with the wheels 700 associated with the rear end axle assembly thereby keeping the track 300 from being dislodged or coming off the wheels 700. It should be noted that dislodgement or track 300 derailing is very costly and time consuming. A common problem with other designs, is that many times the track 300 is ruined or damaged as a result of being dislodged.

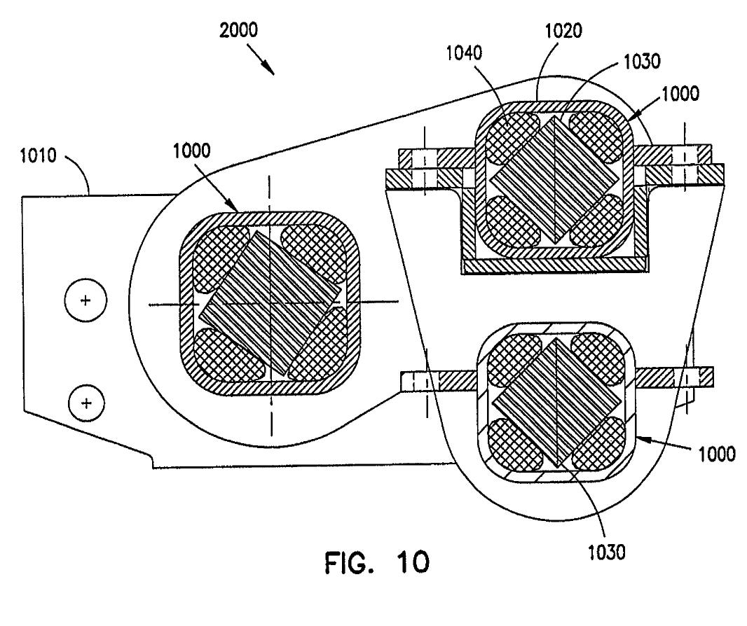

FIG. 10 is a cross-sectional view showing an embodiment of a body mount system 2000, which uses a several suspension units called torsion mounts 1000 to support the body frame 102 on undercarriage frames 210. Each torsion mount 1000 is comprised of a shell or tubular outer bar 1020 of a length of square tubular material. An inner bar 1030 having a substantially square cross section is positioned within the outer bar 1020. Rubber cords 1040 are placed between the outer bar 1020 and the inner bar 1030. The inner bar 1030 is placed on an angle with respect to the inside square cross section of the square tubular stock comprising the outer bar 1020. The inner bar 1030 has a diagonal which is slightly less than the shortest dimension between the walls of the square tubular stock of the outer bar 1020. The inner bar 1030 makes a diamond inside or is fitted within the square tubular stock so that it looks like a diamond within the perimeter of the outer bar 1020. Positioned in the comers of the square tubular stock of the outer bar 1020 are four elastomeric cords or rubber cords 1040 which run the entire length of the outer bar 1020. This arrangement provides for a stiff body mount system 2000 that never requires lubrication and is therefore maintenance free and very reliable.

The torsion mounts 1000 are used throughout the undercarriage 200. Turning briefly to FIG. 2, the X's shown in that figure depict attachments which use the torsion mount 1000. For example, a torsion mount is also used in the multi-axle system 7002 along with two wheel plates 230 and 232 carrying two axle assemblies 710 and 712. Each of the axle assemblies 710 and 712 having three wheels 700 attached thereto. The wheel plates 230 and 232 are attached to one another via a torsion mount 1000 centrally located. The torsion mount 1000 is attached to the undercarriage frame 210 and provides resistive rotation to the attached wheel plates 230 and 232 supporting the two axle assemblies 710 and 712 having three wheels 700 a piece. The end result is an inexpensive component that is impervious to dirt, requires little or no maintenance, and which does not necessarily need to be sealed.

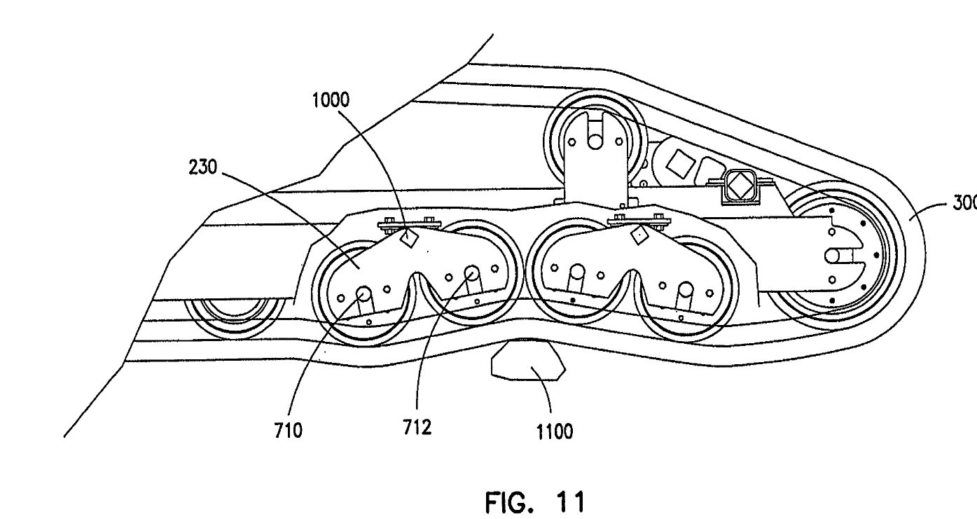

FIG. 11 is a partial perspective view of an embodiment of the undercarriage 200 of the multi-surface vehicle 100 as it engages an obstacle 1100 on the surface 110 being traversed. The resulting amount of stiffness produced by the torsion mounts 1000 in the multi-axle system 7002 allows the wheels 700 to hug the surface 110 even when a rock or other obstacle 1100 is encountered so as to keep more of the track 300 on the surface 110 at any given time. When an obstruction is not encountered, the multi-axle system 7002 having torsion mount 1000 is sufficiently stiff so that the track 300 maintains a substantially unbowed state between the wheels 700 associated with the undercarriage 200.

The body mount systems 2000, dual undercarriages 200, track drive system 9000, axle systems 7001 and 7002, and plurality of wheels 700 all help to maintain optimal surface contact between the track 300 and the underlying surface 110. The various embodiments describe features that help to distribute the downward force imparted by the multi-surface vehicle 100. This results in improved vehicle stability and traction as well as less compaction to the underlying surface 110.

The body mount system 2000 utilizing torsion mounts 1000 allows resistive motion between the body frame 102 and the dual undercarriages 200. The track drive system 9000 routing track 300 around end axle system 7001 and drive sprocket assembly 900 maintains tension of the track 300 and decreases the likelihood of derailment of the track 300. The intermediate multi-axle system 7002 provides a well distributed downward force to each track 300 even when traversing a surface 110 that includes an obstruction. The limited pivoting action of the axle assemblies 710 and 712 pivoting about a central axis provide the degree of freedom necessary to allow the wheels 700 and the track 300 to traverse an underlying obstruction 1100 at the same time providing the resistive force to maintain contact between the plurality of wheels 700 and track 300 and between the track 300 and the underlying surface 110 being traversed. This helps to keep the downward pressure imparted by the vehicle 100 evenly distributed.

The force of the wheels 700 against the inner surface of the track 320 is well distributed. This not only helps to maintain traction and reduce compaction to the underlying surface 110 by the multi-surface vehicle 100, it also helps to reduce forces on the track 300 itself.

One embodiment of the multi-surface vehicle 100 includes a track 300 having an outer surface 301 that includes tread pattern 312 where the track 300 is devoid of stiffeners 350, 352, and 354 within the track 300.

In another embodiment, the multi-surface vehicle 100 includes a drive system 9000 having a track 300 designed to with an outer surface 301 that is an outer surface that is substantially smooth 313. In many applications, the outer surface that is substantially smooth 313 provides optimal surface contact and surface area between the track 300 and the underlying surface 110 being traversed. The increased surface contact helps to improve traction on many surfaces 110 and distributes the pressure over a larger surface area resulting in less compaction to the underlying surface 110 being traversed. Use of the track 300 with a substantially smooth 313 outer surface 301 is especially advantageous in applications in which it is important to leave the traversed surface 110 as undisturbed as possible.

In another embodiment, the multi-surface vehicle 100 includes a track 300 having an outer surface 301 that is substantially smooth 313 where the track 300 is devoid of stiffeners 350, 352, and 354 within the track 300.

Advantageously, the vehicle 100 will travel over soft surfaces 110 without causing damage to the surface 110. In addition, unlike other vehicles, the vehicle 100 sinks little in surfaces 110 of soft mud or snow. The resulting vehicle 100 is very effective in transmitting power to the surface 110 over which it passes. The vehicle 100 requires very low maintenance since the bearing sets 750 and 752 associated with the undercarriage includes a plurality of seals 764, 762 and 760. Other suspension components require little or no maintenance. The vehicle 100 also is less prone to track 300 derailment.

In the embodiments presented, the vehicle 100 has dual undercarriages 200 providing the vehicle 100 with a low center of gravity. The low center of gravity provides stability to the vehicle 100 for activities such as traversing steep inclines, operating auxiliary equipment such as a bucket lift and heavy duty loader with a greater lift capacity, or for hauling larger loads.

Because the vehicle 100 has greater efficiency, it requires less power to traverse a surface 110 leaving more power available for other applications or for auxiliary functions. The embodiments presented are capable of light or heavy duty applications including but not limited to light recreational use, heavy duty commercial use, or non-civilian use.

Although specific embodiments have been illustrated and described herein, it is appreciated by those of ordinary skill in the art that any arrangement which is calculated to achieve the same purpose may be substituted for the specific embodiments shown. This application is intended to cover any adaptations or variations of the present invention. Therefore, it is manifestly intended that this invention be limited only by the claims and the equivalents thereof.

What is claimed is:

1. A drive system for driving a vehicle over a surface comprising:
a flat track having an inner surface and an outer surface;
driving lugs attached to the inner surface of the flat track;
a driver for driving against the driving lugs, said driver positioned above the surface over which the vehicle is driven.

2. The drive system of claim 1 wherein the flat track is held in substantially constant tension.

3. The drive system of claim 1 further comprising:
a first end roller; and
a second end roller, said driver, said first end roller and said second end roller fixed with respect to the flat track such that the flat track is held in substantially constant tension.

4. A vehicle for traversing a surface comprising:
a track further comprising:
an inner surface, said inner surface including a plurality of driving lugs; and
a substantially smooth outer surface;
a driver sprocket, said driver sprocket engaging at least some of said plurality of driving lugs; and
a plurality of wheels contacting the inner surface of the track as the outer surface of the track engages the ground, said plurality of wheels closely spaced such that the flexing of the track is minimized between each of the wheels as the vehicle traverses the ground.

5. The vehicle of claim 4 wherein the plurality of wheels are mounted on axle assemblies, each of said axle assemblies including at least two wheels.

6. The vehicle of claim 4 wherein the driving lugs on the inner surface of the track are aligned, and said plurality of wheels are aligned so that the driving lugs pass between the wheels in contact with the inner surface of the track.

7. The vehicle of claim 4 further comprising a track idler wherein the driver sprocket is in a fixed position toward the rear of the vehicle and the track idler is in a fixed position toward the front of the vehicle and wherein the driver sprocket and track idler define the upper boundaries in the track's path of travel.

8. The vehicle of claim 4 wherein the driver sprocket further includes:
a plurality of annular shafts;
a rotatable sleeve surrounding each annular shaft for driving the driving lugs; and
at least one scraper arcuate in shape and positioned near the rotatable sleeves for removing and carrying debris away from the driver sprocket and the rotatable sleeves.

9. The vehicle of claim 4 further comprising:
opposing undercarriage frames on each side of the vehicle, each undercarriage frame supporting a driver sprocket;
a body frame supported by the undercarriage frames; and
a means for mounting the body frame onto the undercarriage frames.

10. The vehicle of claim 9 wherein the means for attaching the body frame onto the undercarriage frames further comprises:
a first body mount toward the front of the vehicle; and
a second body mount toward the rear of the vehicle;
each body mount including at least one torsion mount such that the body mounts allow for limited rotation between the body frame and the undercarriage frame.

11. The vehicle of claim 10 wherein the first body mount toward the front of the vehicle further comprises:
a first torsion mount laterally coupled to the undercarriage frame; and a second torsion mount laterally coupled to the body frame; and
a plate having an end for attaching to the fourth torsion mount and having an opposing end for attaching to the fifth torsion mount, the plate being attached between the fourth and fifth torsion mounts such that limited rotation is permitted between the body frame and the undercarriage frame toward the front of the vehicle.

12. The vehicle of claim 10 wherein the second body mount toward the rear of the vehicle further comprises:
a first torsion mount laterally coupled to an undercarriage frame;
a second torsion mount positioned directly above the first torsion mount and coupled to the first torsion mount by parallel brackets;
a third torsion mount laterally coupled to the body frame; and
a plate having an end for mounting to the second torsion mount and having an opposing end for mounting to the third torsion mount; the plate connecting the second torsion mount and the third torsion mount such that limited rotation is permitted between the undercarriage frame and the body frame toward the rear of the vehicle.

13. The vehicle of claim 10 wherein the torsion mount further comprises:
an inner bar;
a tubular outer bar surrounding the inner bar, the inner bar having a longer length than the outer bar so that the ends of the inner bar extend beyond the outer bar; and
an elastomeric portion fitting within the spaces between the inner bar and the outer bar and wherein the elastomeric portion of the torsion mount allows for limited rotation between the inner bar and the outer bar.

14. The vehicle of claim 9 further comprising:
a first end axle assembly supporting a portion of the plurality of wheels; and
a second end axle assembly supporting a portion of the plurality of wheels;
the driver sprocket, the first end axle assembly and the second end axle assembly fixed with respect to the undercarriage frame such that the flat track is held in substantially constant tension about the sprocket and the plurality of wheels on the first end axle assembly and the plurality of wheels on the second end axle assembly.

15. The vehicle of claim 9 further comprising at least one multi-axle system for supporting at least a portion of the plurality of wheels, the multi-axle system including:
a plurality of axle assemblies including;
at least one fore axle assembly;
at least one aft axle assembly; and
a means for mounting the fore axle assembly and the aft axle assembly on opposing sides of a central axis such that the fore axle assembly and aft axle assembly have limited pivoting motion about the central axis.

16. The vehicle of claim 15 wherein the means for mounting the fore axle assembly and the aft axle assembly on opposing sides of a central axis comprises:
a central torsion mount;
a means for laterally coupling the central torsion mount to the undercarriage frame;
at least two plates coupled to the central torsion mount for supporting the fore axle assembly and aft axle assembly therebetween, the plates having limited pivoting motion about the central torsion mount;
the plates having a means for supporting at least one fore axle assembly and at least one aft axle assembly on opposing sides of the torsion mount.

17. The vehicle of claim 16 wherein the means for laterally coupling the central torsion mount to the undercarriage frame is comprised of a cross member laterally connected to the undercarriage frame, the cross member shaped to support the central torsion mount.

18. A track for an all surface vehicle comprising:
an inner surface, the inner surface including a plurality of driving lugs; and
a substantially smooth outer surface.

19. The track of claim 18 further comprises rubber and layers of flexible strengthening material incorporated with the rubber.

20. The track of claim 18 wherein the track is devoid of reinforcing rods.

21. The track of claim 18 wherein the track has beveled edges.

22. A drive system for driving a vehicle over a surface comprising:
a track having an inner surface and a substantially smooth outer surface;
beveled driving lugs attached to the inner surface of the track;
a driver sprocket assembly for driving against the driving lugs, the driver sprocket positioned above the surface over which the vehicle is driven
wheels mounted on an axle system such that the track is routed around the driver sprocket assembly and the axle system, the driver sprocket and axle system fixed to maintain tension of the track.
